(19) United States
(12) Patent Application Publication
(10) Pub. No.: US 2015/0356723 A1
(43) Pub. Date: Dec. 10, 2015

(54) SYSTEM FOR DIAGNOSING WASTEWATER, APPARATUS FOR DIAGNOSING WASTEWATER AND METHOD FOR PROCESSING WASTEWATER DATA

(71) Applicant: TSENG-HSIAN LIN, TAIPEI (TW)

(72) Inventor: TSENG-HSIAN LIN, TAIPEI (TW)

(21) Appl. No.: 14/535,035

(22) Filed: Nov. 6, 2014

(30) Foreign Application Priority Data
Jun. 6, 2014 (CN) 201410249896.7
Jun. 6, 2014 (TW) 103119671

(51) Int. Cl. G06T 7/00; G06F 17/30

(52) U.S. Cl. CPC G06T 7/0004; G06F 17/3028

(57) ABSTRACT

A system for diagnosing wastewater including a terminal device and a cloud data processing center is provided. The terminal device acquires a microscopic image data of microbiota from a water sample, and converts the microscopic image data into a transmission message. The cloud data processing center receives the transmission message, and performs analysis and/or comparison calculation with respect to microbiota on the transmission message. After the analysis and comparison calculation, the cloud data processing center outputs a corresponding biological treatment message to the terminal device based on the result of analysis and comparison. Moreover, the practitioner can obtain the information of diagnostic conclusion and biological treatment message for treatment process immediately. Furthermore, an apparatus for diagnosing wastewater, a method of terminal data processing for diagnosing wastewater, and a method of remote data processing for diagnosing wastewater are disclosed in the present invention.

### CROSS-REFERENCE TO RELATED APPLICATION

The application claims the benefit of Taiwan Patent Application No. 103119671 and People's Republic of China (PRC) Patent Application No. 201410249896.7, both filed on Jun. 6, 2014, the entirety of which are incorporated by reference herein.

### TECHNICAL FIELD

The present disclosure relates to a system for diagnosing wastewater, apparatus for diagnosing wastewater and method for processing wastewater data, in particular, to a system for diagnosing wastewater, apparatus and method for processing wastewater data capable of determining microbiota by using a microscopic image analysis of a cloud server.

### BACKGROUND

The system of wastewater biological treatment can be classified into anaerobic treatment and aerobic treatment. The anaerobic treatment is frequently used to treat high-concentration wastewater, and the aerobic treatment is commonly used in industry. In addition, the biological aerobic treatment is divided into multiple treatment procedures, such as activated sludge process, contact oxidation process, oxidation ditch process, constructed wetlands or ecological engineering process, and the user can select at least one of these treatment procedures according to the individual characteristic of each treatment procedure, and the environment condition of the place to be treated, such as river, lake, reservoir, wastewater treatment station or wastewater disposal facility.

Moreover, the most problems of water quality are caused by the changing of the microbiota. General wastewater improvement system usually adopts biological treatment process as means of improving wastewater, and the biological treatment process mainly expedite the metabolic function of microorganism in the wastewater, whereby the microbiota in the wastewater can be restored to the status of normal water quality. Therefore, the essence of the problem of water quality and corresponding improvement condition can be synthetically determined based on the observation of the microbiota.

The microscope is usually used to observe the microbiota in the wastewater at the present industry, and then determine the species, number and type of the microbiota in the wastewater. Finally, the corresponding biological treatment is performed on the wastewater according to these data, to achieve the objective of improving and restoring the water quality.

However, there are numerous species of microbiota in the wastewater. The wastewater practitioner usually must acquire microscopic image of the water sample to be tested first, and then manually compare the acquired image with a microbiota lookup table, and determine the species, type and number of the dominant microbiota in the acquired microscopic image. Finally, a manual comparison is conducted based on a relationship table between the microbiota and the biological treatment process, to determine the corresponding biological treatment process.

The above-described conventional wastewater treatment method is quite tedious, such that during a wastewater treatment system abnormality, it is difficult for the practitioner to immediately resolve the abnormal condition and restore the normal operation of the wastewater treatment system.

### SUMMARY

Accordingly, the present disclosure provides a system for diagnosing wastewater, which utilizes a cloud computing technology to send a microscopic image of a microbiota acquired by a terminal device to a cloud data processing center. The terminal can show the computing result from the cloud server immediately by the computing process, the result includes species, type, number and corresponding biological treatment message of the microbiota.

In accordance with one aspect of the present invention, a system for diagnosing wastewater of the present disclosure is provided. The system includes a terminal device and a cloud data processing center. The terminal device acquires a microscopic image data of the microbiota from a water sample to be tested, converts the microscopic image data into a transmission message, and sends the transmission message to the cloud data processing center. The cloud data processing center performs analysis and/or comparison calculation with respect to microbiota on transmission message and outputs a corresponding biological treatment message to the terminal device based on results of the analysis and/or comparison in response to the received transmission message.

In accordance with one aspect of the present invention, an apparatus for diagnosing wastewater of the present disclosure is provided. The apparatus includes: an image acquiring unit, a memory module, a processing module and a display module. The image acquiring unit acquires microscopic image data of a microbiota from a water sample to be tested. The memory module stores the microbiota data and the biological treatment message. The processing module is coupled to the image acquiring unit and produces a transmission message based on data compression of the microscopic data, and conducts a comparison of the microbiota data stored in the memory module based on the transmission message, and determines a biological treatment message corresponding to the transmission message, based on results of the comparison, from the memory module. The display module is coupled to the processing module and displays the microscopic image and/or the biological treatment message.

In accordance with one aspect of the present invention, a method of terminal data processing for diagnosing wastewater of the present disclosure is provided. The method is performed by a terminal device and includes following steps: microscopic image data of a microbiota is acquired from a water sample to be tested; converting the microscopic image data into a transmission message; the transmission message is sent to the cloud data processing center; and a corresponding biological treatment message is received from the cloud data processing center.

In accordance with one aspect of the present invention, a method of remote data processing for diagnosing wastewater of the present disclosure is provided. The method is performed by a cloud data processing center and includes following steps: the transmission message is received from the terminal device; an analysis and/or comparison calculation with respect to microbiota is performed on the transmission message; and a biological treatment message corresponding to the transmission message is sent to the terminal device, based on results of the analysis and/or comparison calculation.

To sum up, the system for diagnosing wastewater provided by the embodiments of the present disclosure is to perform image comparison calculation on the microbiota by using the cloud computing technology to determine a dominant microbiota, and then search a corresponding biological treatment strategy based on the dominant microbiota, and send a species, type, number and corresponding biological treatment message of the microbiota to a terminal device for presentation.

Therefore, when a wastewater treatment system becomes abnormal accidentally and causes the production of the wastewater, the system for diagnosing wastewater of the present disclosure can promptly provide the cause of abnormality and corresponding improvement actions to the wastewater practitioner, so that the practitioner can restore the normal operation of the wastewater treatment system immediately.

In order to further understand the techniques, means and effects of the present disclosure, the following detailed descriptions and appended drawings are hereby referred to, such that, and through which, the purposes, features and aspects of the present disclosure can be thoroughly and concretely appreciated, however, the appended drawings are merely provided for reference and illustration, without any intention that they be used for limiting the present disclosure.

### BRIEF DESCRIPTION OF THE DRAWINGS

These and other features, aspects, and advantages of the present invention will become better understood with regard to the following description and accompanying drawings as follows.

FIG. 1 is a schematic view of structure of a system for diagnosing wastewater of an embodiment of the present disclosure.

FIG. 2 is a functional block view of the system for diagnosing wastewater of an embodiment of the present disclosure.

FIG. 3 is a schematic view of image of microbiota under a microscope of an embodiment of the present disclosure.

FIG. 4 is a flowchart of a method of data processing for diagnosing wastewater at terminal device of an embodiment of the present disclosure.

FIG. 5 is a flowchart of a method of remote data processing for diagnosing wastewater of an embodiment of the present disclosure.

### DETAILED DESCRIPTION

The present disclosure will now be described more specifically with reference to the following embodiments. It is to be noted that the following descriptions of embodiments of this invention are presented herein for the purposes of illustration and description only; it is not intended to be exhaustive or to be limited to the precise form disclosed.

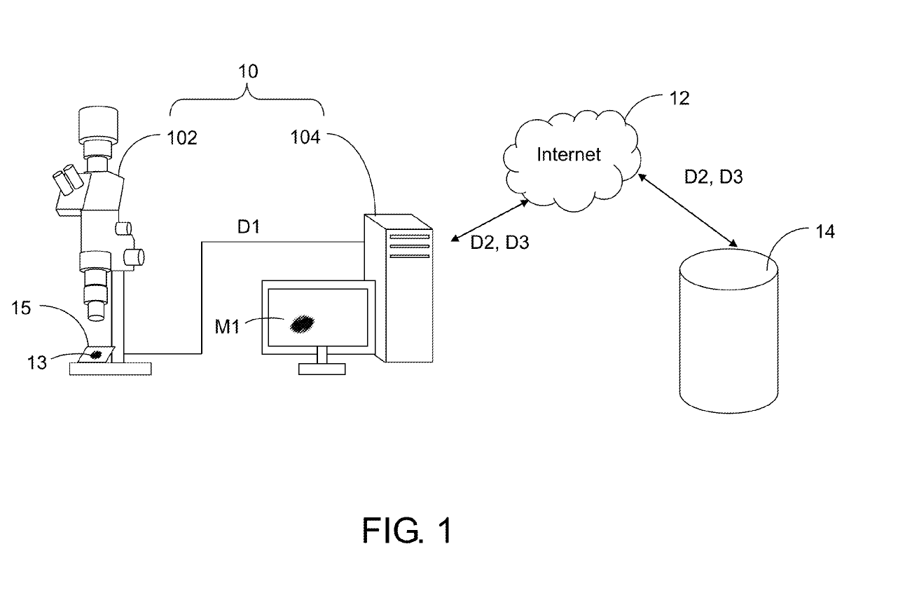

Please refer to FIG. 1, which is a schematic view of structure of a system for diagnosing wastewater of an embodiment of the present disclosure. The system for diagnosing wastewater 1 relates to a cloud computing process technology. In detail, the system for diagnosing wastewater 1 utilizes the capability of analysis, comparison calculation, and data management of a cloud server to enable the practitioner to obtain a cause of the abnormality and corresponding wastewater treatment strategy promptly when the wastewater treatment system becomes abnormal. Therefore, manpower consumption and time consumption for determining the cause of abnormality and corresponding treatment strategy by traditional manual comparison can be reduced.

The system for diagnosing wastewater 1 includes a terminal device 10 and a cloud data processing center 14. The terminal device 10 and the cloud data processing center 14 are linked with each other through an Internet 12, and perform data communication with each other through the Internet 12. The Internet 12 uses a TCP/IP communication protocol. However, the present disclosure is not limited to the Internet 12. Any network capable of being applied for data communication with the terminal device 10 and the cloud data processing center 14 in wireless or wired way is covered by the range of the present disclosure. For example, local area network (LAN), wireless local area network (WLAN), public switching telephone network (PSTN), wireless network and so on.

The terminal device 10 acquires microscopic image data D1 of microbiota M1 in the water sample to be tested 13 and converts the microscopic image data D1 into a transmission message D2. The water sample to be tested 13 can be acquired from various wastewater treatment system. For example, in the wastewater treatment system using activated sludge process, the practitioner can use a ladle or a sampler to get the water sample to be tested 13 at the place close to an outlet of an aeration tank.

The terminal device 10 includes an image acquiring unit 102 and a terminal computing unit 104. The image acquiring unit 102 and the terminal computing unit 104 are coupled with each other. The image acquiring unit 102 can send the microscopic image data D1 to the terminal computing unit 104, and the terminal computing unit 104 can perform functional control on the image acquiring unit 102, such as functional adjustment control for magnification ratio, shooting distance or shooting angle. The functional adjustment for the image acquiring unit 102 can also be performed by an adjusting element installed in the image acquiring unit 102, such as a rotary switch.

The terminal device 10 can be an individual hand-held integrated device, such as a portable device for diagnosing wastewater; or, the terminal device 10 can be a combination of two or more individual devices, such as a combination of a camera microscope and a laptop computer. Therefore, the individual device or combination of individual devices having functions of acquiring microscopic image, computation and communication can be applied as the terminal device 10, and be covered in the range of the present disclosure.

As shown in FIG. 1, the image acquiring unit 102 acquires a microscopic image from the water sample to be tested 13 on a glass slide 15, and then the microbiota M1 of the water sample to be tested 13 can be viewed under a microscopic field by the image acquiring unit 102 after the function of the image acquiring unit 102 is appropriately adjusted. By executing the function of acquiring image, the image acquiring unit 102 can produce the image of the microbiota M1 and corresponding microscopic image data D1. The image acquiring unit 102 can send the microscopic image data D1 to the terminal computing unit 104, and the image of the microbiota M1 can be represented on the terminal computing unit 104. The terminal computing unit 104 performs data compression on the microscopic image data D1 to produce a transmission message D2.

The terminal computing unit 104 sends the transmission message D2 to a remote cloud data processing center 14 through the Internet 12. The cloud data processing center 14 performs analysis calculation on the transmission message D2 to determine type and number of various microbiotas M1 in the water sample to be tested 13 indicated by the transmission message D2. Next, the cloud data processing center 14 compares the determined type of the various microbiotas M1 with the microbiota, among others, pre-stored in a database, to determine the species of various microbiotas M1 in the water sample to be tested 13, such as whipworm or vorticella. Next, the cloud data processing center 14 determines a dominant microbiota in the water sample to be tested 13, based on the species and number of the microbiota M1, and determines a corresponding biological treatment message D3 based on the dominant microbiota. The biological treatment message D3 is a related biological treatment strategy about the problem of wastewater treatment.

The cloud data processing center 14 sends the corresponding biological treatment message D3 to the terminal device 10 via the Internet 12. Therefore, the terminal device 10 can represent related data of the species, type and number of the various microbiotas M1 in the water sample to be tested 13, and the related biological treatment strategy about the problem of wastewater treatment.

Please refer to Table 1, which is a relationship table between microbiota and biological treatment strategy. As shown in Table 1, when it is determined that the dominant microbiota in the water sample to be tested 13 are: (1) Paramecium caudatum, (2) Colpidium, (3) Colpoda, (4) Zooflagellate, (5) Bodo, (6) Oicomonas; and the corresponding biological treatment strategy is: (1) the pretreatment efficiency is increased to reduce the load; (2) a backwash action is performed; and (3) the aeration amount of the contact aeration tank is increased.

TABLE 1

| Microbiota | Treatment Strategy |
|---|---|
| Dominant microbiota: | 1. Increasing the |
| 1. Beggiatoa alba | pretreatment efficiency to |
| 2. Zoogloea ramigera | reduce the loading; |
| Microorganism(s) a large amount of | 2. Performing a backwash |
| which may exist: | action; |
| 1. Paramecium caudatum | 3. Increasing the aeration |
| 2. Colpidium | amount of the contact |
| 3. Colpoda | aeration tank. |
| 4. Zooflagellate | |
| a. Bodo | |
| b. Oicomonas | |
| Dominant microbiota: | The current status remains. |
| 1. Vorticella | |
| 2. Trauben Vorticella | |
| a. Epistylis lacustris | |
| b. Opercularia | |
| 3. Rotifer | |
| a. Philodina | |
| b. Rotaria | |
| In addition, there are a large amount of | |
| nematodes, oligochaeta and microthrix | |
| parvicella. | |
| Dominant microbiota: | 1. Increasing volume loading; |
| 1. Testate amoebae | 2. Performing batch |
| a. Euglypha | operation; |
| b. Arcella | 3. Increasing organic loading |
| c. a reduced amount of Centropyxis, | gradually. |
| and a large amount of nitrobacteria | |
| (or Nitrosomonas) | |
| Dominant microbiota: | The current status remains. |
| 1. Rotifer | |
| a. Philodina | |
| b. Rotaria | |
| 2. Nematodes | |
| 3. Larger eumetazoa, such as primitive | |
| oligochaeta. | |
| Dominant microbiota: | 1. Increasing volume loading; |
| 1. Crustacean | 2. Performing batch |
| a. Moina | operation; |
| b. Cyclops | 3. Increasing organic loading |
| c. Alona | gradually. |
| 2. a large amount of primitive oligochaeta. | |
| Dominant microbiota: | 1. Checking whether the |
| 1. Beggiatoa alba | system is blocked and |
| 2. Caenomorpha | removing the blocking |
| a. Caenomorpha | problem; |
| b. Metopus | 2. Investigating |
| 3. Paramecium | characteristic of the |
| | wastewater, and |
| | pre-clearing the sulfide; |
| | 3. Increasing the aeration |
| | amount of the equalization |
| | tank and system. |
| Dominant microbiota: | 1. Increasing volume loading; |
| 1. Testate amoebae | 2. Batch operation; |
| a. Euglypha | 3. Increasing organic loading |
| b. Arcella | gradually. |
| c. a reduced amount of Centropyxis, and | |
| a large amount of nitrobacteria | |
| (or Nitrosomonas) | |

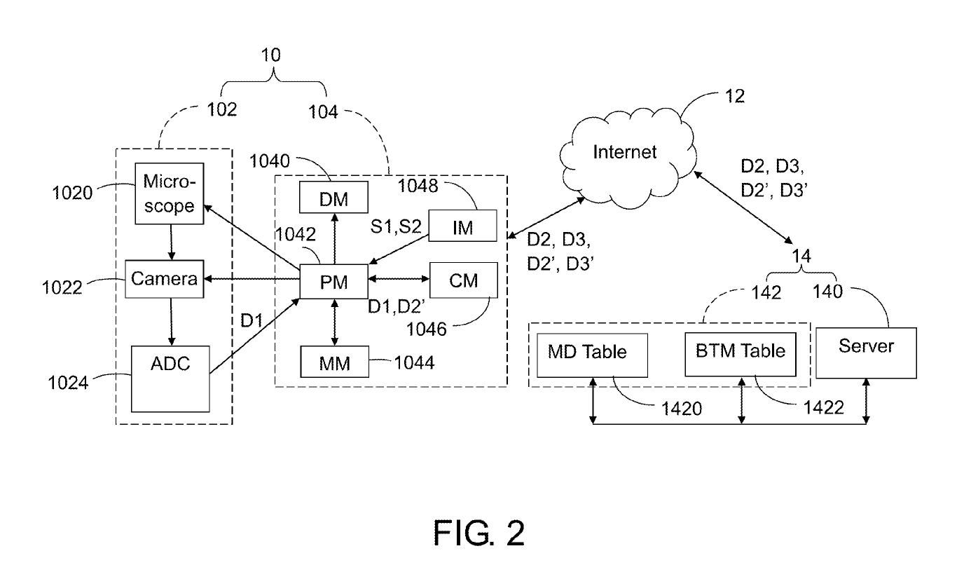

Please refer to FIG. 2, which is a functional block view of the system for diagnosing wastewater of an embodiment of the present disclosure. The image acquiring unit 102 of the terminal device 10 used in this embodiment includes a microscope 1020, a camera 1022 and an analog-to-digital converter 1024. The microscope 1020 can perform function of microscopic magnification on an object based on an observation magnification ratio, to enable a practitioner to watch the microcosmic status of the object. In this embodiment, the main object to be observed is the microbiota from a water sample to be tested. Therefore, any device used to determine the microcosmic status of the microbiota is within the range of the present disclosure.

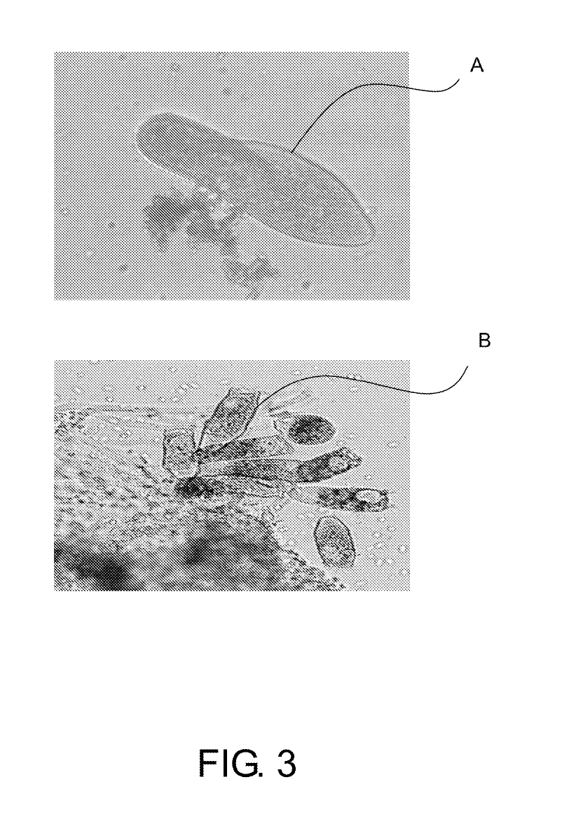

Please refer to FIG. 3, which is a schematic view of image of microbiota under a microscope of an embodiment of the present disclosure. FIG. 3 shows the type of microbiota M1 of parameciums A and vorticellas B observed in the microscope 1020.

The camera 1022 is coupled to the microscope 1020 for acquiring the image of the microbiota magnified by the microscope 1020. In this embodiment, the camera 1022 is a CCD (charge-coupled device) camera using a CCD imaging technology or a CMOS (complementary metal-oxide-semiconductor) camera using a CMOS imaging technology. However, the present disclosure is not limited to these two imaging technologies. Any camera 1022 capable of acquiring image of the microbiota magnified by the microscope 1020 is covered in the range of the present disclosure.

The analog-to-digital converter 1024 is mainly used to convert an analog image of the microbiota acquired by the camera 1022 into a digital image. In addition, the analog-to-digital converter 1024 can be integrated into the camera 1022, to enable the camera 1022 to produce the digital image directly, and such camera 1022 is a digital camera. Therefore, the analog-to-digital converter 1024 can be integrated with or separated from the camera 1022 in structure.

Therefore, the image of the microbiota M1 of the water sample to be tested 13 can be viewed under a microscopic field after the microscope 1020 of the image acquiring unit 102 is appropriately adjusted. The camera 1022 can acquire the magnified image of the microbiota M1, and produce a corresponding digital microscopic image data D1.

Please refer to FIG. 2 again. The terminal computing unit 104 of the terminal device 10 used in this embodiment includes a processing module 1042 and a communication module (CM) 1046. The processing module 1042 is coupled between the image acquiring unit 102 and the communication module 1046. The processing module 1042 receives the digital microscopic image data D1 from the image acquiring unit 102, and performs data compression on the digital microscopic image data D1 to produce a transmission message D2, and sends the transmission message D2 to the communication module 1046. The communication module 1046 sends the transmission message D2 to the cloud data processing center 14 through the Internet 12, and receives the biological treatment message D3 sent from the cloud data processing center 14 through the Internet 12.

The communication module 1046 can be selected from a group consisted of GSM (Global System for Mobile Communications) system, 3G (3^{rd}-Generation) system, HSPA (High Speed Packet Data Access) system, LTE (Long Term Evolution) system and WiMax (Worldwide Interoperability for Microwave Access) system which are different data communication/transmission technologies. However, the present disclosure is not limited to these communication/transmission technologies, any communication module capable of performing data transmission/communication through the Internet 12 and the cloud data processing center 14 is covered in the range of the present disclosure.

Please refer to FIG. 2. The processing module (PM) 1042 of the terminal computing unit 104 is further coupled to a memory module (MM) 1044, a display module (DM) 1040 and an input module (IM) 1048. The memory module 1044 is used to store data. The display module 1040 is used to present the microscopic image of the microbiota M1, and also present the biological treatment message D3 sent from the cloud data processing center 14. The input module 1048 is used to send a control instruction S1 to the processing module 1042. The processing module 1042 can drive the image acquiring unit 102 to perform the functional adjustment operation of magnification ratio, shooting distance or shooting angle, based on the control instruction S1

In addition, the input module 1048 can further send a parameter setting criterion of a certain condition S2 to the processing module 1042. The parameter setting criterion of a certain condition S2 includes at least one selected from a group consisting of settling volume at 30 min (SV30), dissolved oxygen index (DO), pH index, electrical conductivity (EC), total dissolved solids (TDS), salinity, oxidation-reduction potential (ORP), water color, acidity, alkalinity, hardness, turbidity, metal ion concentration, phosphorus content, nitrogen content, sulfur content, chlorine content, sludge color, sludge recycle ratio (amount of sludge/amount of wastewater), chemical oxygen demand (COD), biochemical oxygen demand (BOD), suspended solids (SS), and any combination thereof. The above data or parameters can be obtained by a related detection means or device on site, which can be done by conventional wastewater treatment technology and so the details of them will not be described for the sake of brevity.

Other embodiment of the processing module 1042 can be used to combine the parameter setting criterion of a certain condition S2 and the digital microscopic image data D1 received from the image acquiring unit 102, and perform data compression on the combined digital microscopic image data D1 to produce a transmission message D2′ and send the transmission message D2′ to the communication module 1046. The communication module 1046 sends the transmission message D2′ to the cloud data processing center 14 through the Internet 12, and receives the biological treatment message D3′ sent from the cloud data processing center 14 through the Internet 12.

Please refer to FIG. 2 again. The cloud data processing center 14 includes a server 140 and a database 142. The server 140 and the database 142 are linked with each other, and the database 142 includes a microbiota data (MD) table 1420 and a biological treatment message (BTM) table 1422.

The server 140 receives the transmission message D2 and D2′ sent from the terminal device 10 through the Internet 12, and conducts a comparison of a microbiota data table 1420 stored in the database 142 based on the transmission message D2 and D2′ and searches for a biological treatment message D3 and D3′ corresponding to the transmission message D2 and D2′, based on results of the comparison, from the biological treatment message table 1422 of the database 142. The various microbiota data, such as contour feature of the microbiota, is pre-stored in the microbiota data table 1420. The biological treatment data corresponding to various dominant microbiotas is pre-stored in the biological treatment message table 1422, as can be referred in Table 1.

The server 140 executes an inner operating system, and performs analysis calculation on the transmission message D2 and D2′ with the microbiota data table 1420 stored in the database 142 for the type and number of the microbiota, to determine the type of the dominant microbiota indicated by the transmission message D2 and D2′. Next, the server 140 conducts a comparison of the type of the dominant microbiota with microbiota data stored in the microbiota data table 1420, to determine the biological species indicated by the dominant microbiota. And the server 140 then conducts the search calculation on the biological treatment message table 1422 based on biological species of the dominant microbiota, to further determine the corresponding biological treatment message D3 and D3′. Finally, the server 140 sends the biological treatment messages D3 and D3′ to the terminal device 10 through the Internet 12, and the content of the biological treatment messages D3 and D3′ are presented by the terminal device 10.

In addition, the terminal device 10 can also be a portable apparatus for diagnosing wastewater, such as cell phone, tablet computer or notebook computer, to enable the practitioner to immediately conduct analysis and comparison calculation on-site at the wastewater place, so that the practitioner can promptly receive the cause of the abnormality and corresponding wastewater treatment strategy when the wastewater treatment system becomes abnormal, and restore the normal operation of the wastewater treatment system immediately. Therefore, the disadvantages of manpower and time consumption due to manual comparison can be improved effectively.

Please refer to FIG. 2. The terminal device 10 can include an image acquiring unit 102, a memory module 1044, a processing module 1042 and a display module 1040, to be an apparatus for diagnosing wastewater. The image acquiring unit 102 includes a microscope 1020, a camera 1022 and an analog-to-digital converter (ADC) 1024. The main function of the image acquiring unit 102 is to acquire the microscopic image data D1 of microbiota M1 from the water sample to be tested 13. Since its related illustration is similar to the above-mentioned content, the details will not be repeated for the sake of brevity. The memory module 1044 stores microbiota data and biological treatment message. In detail, the memory module 1044 stores the microbiota data table including microbiota data stored, and the biological treatment message table including biological treatment data stored correspondingly to dominant microbiota.

The processing module 1042 is coupled to the image acquiring unit 102 and the memory module 1044, and produces the transmission message D2 based on data compression of the microscopic image data D1, and conducts a comparison of the microbiota data stored in the memory module 1044 based on the transmission message D2, and determines a biological treatment message corresponding to the transmission message D2, based on results of the comparison, from the memory module 1044. Since the related illustration is similar to the above-mentioned content, the detailed description of such illustration will not be provided for the sake of brevity. In addition, the display module 1040, coupled to the processing module 1042, and displays the microscopic image and/or the biological treatment message. The related illustration is similar to the above-mentioned content, so its details will not be described for brevity's sake.

Please refer to FIG. 2. The terminal device 10 further includes an input module 1048 to perform the function of the apparatus for diagnosing wastewater. The input module 1048 is coupled to the processing module 1042, for providing a parameter setting criterion of a certain condition to the processing module 1042. The processing module 1042 combines the parameter setting criterion of the certain condition and the microscopic image data D1 and performs data compression to produce the transmission message D2. Since the related illustration is similar to the above-mentioned content, the details will not be repeated for the sake of brevity.

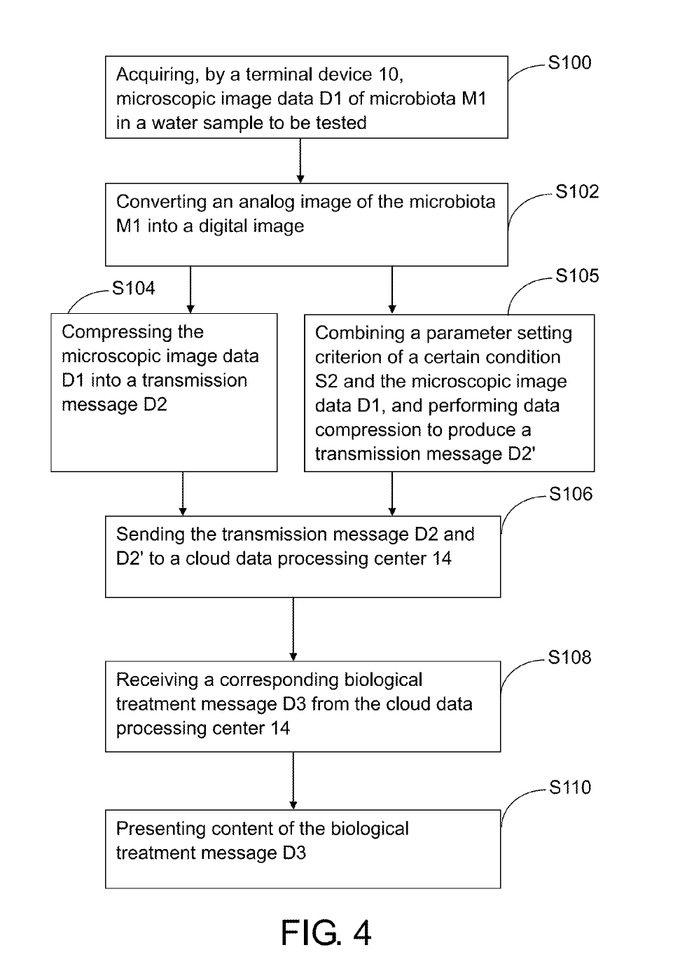

Referring to FIG. 4 as well as FIGS. 1 and 2, FIG. 4 is a flowchart of a method of terminal data processing for diagnosing wastewater of an embodiment of the present disclosure. The method of terminal data processing of the present embodiment is performed by the terminal device 10, as described below.

Firstly, the terminal device 10 acquires microscopic image data D1 of microbiota M1 in the water sample to be tested 13 (S100). Then, the terminal device 10 performs data conversion on the microscopic image data D1, to convert an analog image of the microbiota M1 into a digital image (S102). Next, the terminal device 10 executes an image compression program, to compress the microscopic image data D1 into a transmission message D2 (S104). In addition, the terminal device 10 can also combine a parameter setting criterion of a certain condition S2 and the microscopic image data D1, and performs data compression to produce a transmission message D2′ (S105). Next, the terminal device 10 sends the transmission message D2 and D2′ to a cloud data processing center 14 (S106). Afterward, the terminal device 10 can receive the corresponding biological treatment message D3 from the cloud data processing center 14 (S108), and the content of the biological treatment message D3 is presented or displayed by the terminal device 10 (S110).

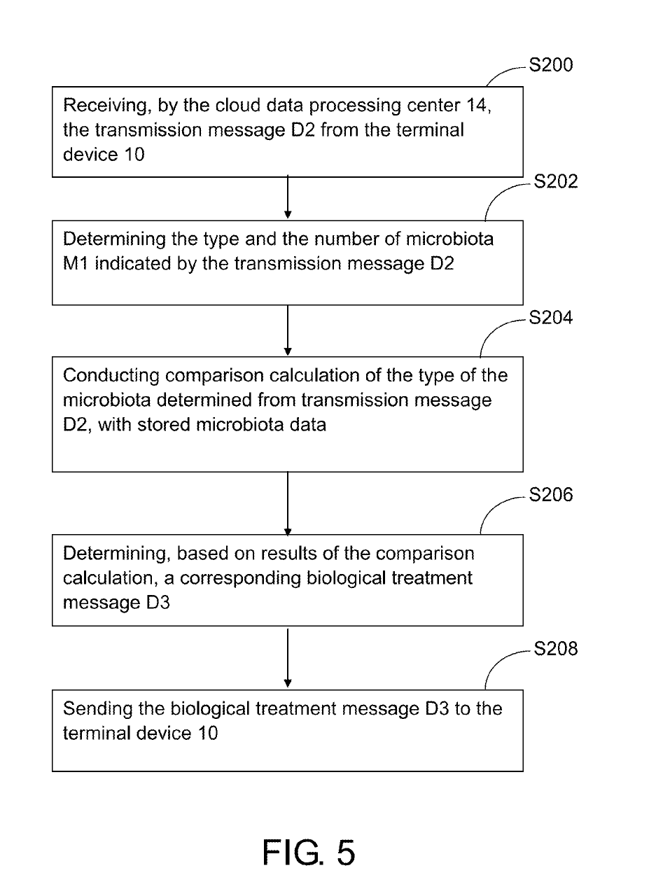

Please refer to FIG. 5, as well as FIGS. 1 and 2. FIG. 5 is a flowchart of method of remote data processing for diagnosing wastewater of another embodiment of the present disclosure. The method of remote data processing is performed by the cloud data processing center 14, and will be described as follows.

Firstly, the cloud data processing center 14 receives the transmission message D2 from the terminal device 10 (S200), and then performs analysis and/or comparison calculation with respect to microbiota on the transmission message D2. The cloud data processing center 14 performs image analysis calculation on the transmission message D2, to determine the type and the number of microbiota M1 indicated by the transmission message D2 (S202). Next, the cloud data processing center 14 conducts comparison calculation of the type of the microbiota determined from transmission message D2, with stored microbiota data (S204). The cloud data processing center 14 then determines, based on results of the comparison calculation in step S204, a corresponding biological treatment message D3 (S206), and sends the biological treatment message D3 to the terminal device 10 (S208).

To sum up, the system for diagnosing wastewater 1 provided by the embodiments of the present disclosure uses the cloud computing technology to perform analysis and comparison calculation on the sample of abnormal wastewater, and then determines the species of the dominant microbiota in the sample of the abnormal wastewater, and then determines the corresponding wastewater biological treatment strategy by the cloud search computing technology.

Therefore, the system for diagnosing wastewater 1 provided by the embodiments of the present disclosure uses the functions of analysis, comparison calculation and data management of the cloud server to enable the practitioner to promptly receive the cause of the abnormality and corresponding waste treatment strategy for the wastewater treatment system and restore the normal operation of the wastewater treatment system immediately. Therefore, the disadvantages of manpower and time consumption due to manual comparison can be improved effectively.

Moreover, all the features of the above embodiments disclosed herein may be replaced by alternative features serving the same, equivalent, or similar purposes. Thus, each feature disclosed is an example of a generic series of equivalent or similar features.

While the invention has been described in terms of various embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A system for diagnosing wastewater, comprising:
a terminal device for acquiring microscopic image data of a microbiota from a water sample to be tested, and converting the microscopic image data into a transmission message; and
a cloud data processing center for receiving the transmission message, and for performing analysis and/or comparison calculation with respect to microbiota on the transmission message, and outputting a corresponding biological treatment message to the terminal device based on results of the analysis and/or comparison calculation in response to the received transmission message.

2. The system for diagnosing wastewater according to claim 1, wherein the terminal device comprises:
an image acquiring unit for acquiring the microscopic image data of the microbiota; and
a terminal computing unit, coupled to the image acquiring unit, for producing the transmission message based on data compression of the microscopic image data.

3. The system for diagnosing wastewater according to claim 2, wherein the image acquiring unit comprises:
a microscope for magnifying the microbiota in the water sample to be tested with respect to a specific observation magnification ratio; and
a camera, coupled to the microscope, for acquiring a magnified image of the microbiota.

4. The system for diagnosing wastewater according to claim 3, wherein the camera is a charged-coupled device (CCD) camera or a complementary metal-oxide-semiconductor (CMOS) camera.

5. The system for diagnosing wastewater according to claim 3, wherein the image acquiring unit further comprises an analog-to-digital converter for converting an analog image of the microbiota into a digital image.

6. The system for diagnosing wastewater according to claim 2, wherein the terminal computing unit comprises:
a processing module, coupled to the image acquiring unit, for producing the transmission message based on data compression of the microscopic data; and
a communication module, coupled to the processing module, for sending the transmission message to the cloud data processing center.

7. The system for diagnosing wastewater according to claim 6, wherein the terminal computing unit further comprises: a memory module, coupled to the processing module, for storing data.

8. The system for diagnosing wastewater according to claim 6, wherein the terminal computing unit further comprises: a display module, coupled to the processing module, for displaying the microscopic image and/or the biological treatment message.

9. The system for diagnosing wastewater according to claim 6, wherein the terminal computing unit further comprises: an input module, coupled to the processing module, for providing a parameter setting criterion of a certain condition to the processing module.

10. The system for diagnosing wastewater according to claim 9, wherein the certain condition includes at least one selected from a group consisting of settling volume at 30 min (SV30), dissolved oxygen index (DO), pH index, electrical conductivity (EC), total dissolved solids (TDS), salinity, oxidation-reduction potential (ORP), water color, acidity, alkalinity, hardness, turbidity, metal ion concentration, phosphorus content, nitrogen content, sulfur content, chlorine content, sludge color, sludge recycle ratio (amount of sludge/amount of wastewater) and any combination thereof.

11. The system for diagnosing wastewater according to claim 9, wherein the processing module combines the parameter setting criterion of the certain condition and the microscopic image data and performs data compression to produce the transmission message.

12. The system for diagnosing wastewater according to claim 2, wherein the cloud data processing center is linked to the terminal computing unit through an internet.

13. The system for diagnosing wastewater according to claim 2, wherein the cloud data processing center comprises:
a database; and
a server, linked to the database, for conducting a comparison of microbiota data stored in the database based on the transmission message, and searching for a biological treatment message corresponding to the transmission message, based on results of the comparison, from the database.

14. The system for diagnosing wastewater according to claim 13, wherein the database includes a microbiota data table including microbiota data stored, and a biological treatment message table including biological treatment data stored correspondingly to dominant microbiota.

15. A method of terminal data processing for diagnosing wastewater by a terminal device, the method comprising:
acquiring microscopic image data of microbiota from a water sample to be tested;
converting the microscopic image data into a transmission message;
sending the transmission message to a cloud data processing center; and
receiving a biological treatment message corresponding to the transmission message, produced by the cloud data processing center.

16. The method of terminal data processing for diagnosing wastewater according to claim 15, further comprising:
producing the transmission message based on data compression of the microscopic image by the terminal device.

17. The method of terminal data processing for diagnosing wastewater according to claim 15, further comprising:
converting an analog image of the microbiota into a digital image by the terminal device.

18. The method of terminal data processing for diagnosing wastewater according to claim 15, further comprising:
combining a parameter setting criterion of a certain condition and the microscopic image data and performing data compression to produce the transmission message by the terminal device.

19. The method of terminal data processing for diagnosing wastewater according to claim 15, further comprising:
displaying the corresponding biological treatment message by the terminal device.

20. A method of remote data processing for diagnosing wastewater by a cloud data processing center, comprising:
receiving a transmission message from a terminal device;
performing analysis and/or comparison calculation with respect to microbiota on the transmission message; and
sending, based on results of the analysis and/or comparison calculation, a biological treatment message corresponding to the transmission message to the terminal device.

21. The method of remote data processing for diagnosing wastewater according to claim 20, further comprising:
determining a type and number of the microbiota indicated by the transmission message, through analysis and calculation by the cloud data processing center.

22. The method of remote data processing for diagnosing wastewater according to claim 21, further comprising:
conducting a comparison of the type and number of the microbiota determined from the transmission message, with stored microbiota data by the cloud data processing center.

23. The method of remote data processing for diagnosing wastewater according to claim 22, further comprising:
determining the biological treatment message corresponding to the transmission message, based on results of the comparison, by the cloud data processing center.

24. An apparatus for diagnosing wastewater, comprising:
an image acquiring unit for acquiring microscopic image data of microbiota from a water sample to be tested;
a memory module, for storing microbiota data and biological treatment message;
a processing module, coupled to the image acquiring unit and the memory module, for producing a transmission message based on data compression of the microscopic data, and for conducting a comparison of the microbiota data stored in the memory module based on the transmission message, and for determining a biological treatment message corresponding to the transmission message, based on results of the comparison, from the memory module; and
a display module, coupled to the processing module, for displaying the microscopic image and/or the biological treatment message.

25. The apparatus for diagnosing wastewater according to claim 24, wherein the image acquiring unit comprises:
a microscope for magnifying the microbiota in the water sample to be tested with respect to a specific observation magnification ratio; and
a camera, coupled to the microscope, for acquiring a magnified image of the microbiota.

26. The apparatus for diagnosing wastewater according to claim 25, wherein the image acquiring unit further comprises an analog-to-digital converter for converting an analog image of the microbiota into a digital image.

27. The apparatus for diagnosing wastewater according to claim 24, further comprising: an input module, coupled to the processing module, for receiving a parameter setting criterion of a certain condition and providing the parameter setting criterion of the certain condition to the processing module.

28. The apparatus for diagnosing wastewater according to claim 27, wherein the processing modules combines the parameter setting criterion of the certain condition and the microscopic image data, and performs data compression to produce the transmission message.
